(19) United States
(12) Patent Application Publication
(10) Pub. No.: US 2002/0145665 A1
(43) Pub. Date: Oct. 10, 2002

(54) Vehicle-use surroundings monitoring system

(75) Inventors: Naoto Ishikawa, Shizuoka (JP); Hiroyuki Ogura, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: Yazaki Corporation, Tokyo (JP)

(21) Appl. No.: 10/118,026

(22) Filed: Apr. 9, 2002

(30) Foreign Application Priority Data
Apr. 10, 2001 (JP) 2001-111198

(51) Int. Cl. H04N 7/18

(52) U.S. Cl. 348/148; 348/143; 348/169

(57) ABSTRACT

A vehicle-use surroundings monitoring system which prevents a stationary object from being detected as an approaching object thereby to improve a detection accuracy of the approaching object. An onboard image-taking means 1 image-takes the surroundings of a vehicle to obtain a taken-image. An approaching object detecting means 3a-1 detects a real approaching object except a stationary object to be mis-detected as an approaching object by making use of the same point (corresponding points) in two images taken by an image-taking means with an interval of a specified time.

### BACKGROUND OF THE INVENTION

1. Field of the invention

The present invention relates generally to a vehicle-use surroundings monitoring system and more particularly to a vehicle-use surroundings monitoring system which monitors the surroundings of a vehicle for giving alarm to a driver by detecting another vehicle approaching from the surroundings of the subject traveling vehicle by using an image obtained by image-taking the road around the subject vehicle by means of an image-taking means such as a camera installed on the subject vehicle.

2. Description of the Related Art

For example, when a vehicle (the subject vehicle) traveling on the road, such as a highway, with plural lanes changes the lane and simultaneously another vehicle is traveling in the vicinity in an adjacent lane and is catching up with the subject vehicle from the rear-and-side, if the subject vehicle carries out the change of the lane while not awaring of the existence of another vehicle, a big accident would occur.

And, when another vehicle travels behind the subject vehicle on the same lane as the subject vehicle with a higher speed and if the subject vehicle, for example, brakes suddenly, a collision would occur. Therefore, secure awareness of another vehicle in the vicinity is desirable.

Further, when the subject vehicle changes the lane and another vehicle slower than the subject vehicle is traveling obliquely ahead of the subject vehicle on the adjacent lane, there would also be a danger of collidation, which requires secure awareness of another vehicle in the vicinity.

A vehicle-use surroundings monitoring system disclosed in Japanese Patent Application Laid-open No. 7-50769 is provided for solving the above problems. This vehicle-use surroundings monitoring system will be described in reference to FIGS. 10a-10d, which explain a change of a rear-and-side image obtained by a camera 1. FIGS. 10b,10c show images taken by the camera 1 of the subject vehicle at time t, t+Δt respectively.

When the subject vehicle goes straight on a flat road, for example a road sign and a building shown in FIG. 10a are imaged as shown in FIGS. 10b, 10c at time t, t+Δt respectively. When corresponding points in the two images are searched and connected, velocity vectors, i.e. optical flows, shown in FIG. 10d are obtained. The prior art vehicle-use surroundings monitoring system detects the existence of another vehicle approaching the subject vehicle by monitoring a relative location between the subject vehicle and another vehicle traveling nearby by using the optical flow and raises an alarm.

In another prior art, corresponding points (the same point) on the two images are searched, positions of these points are calculated by making use of the parallax of, for example, two cameras, and an alarm is generated.

In still another prior art shown in FIG. 11, white lines of the lane on which the subject vehicle travels are detected by image-processing a taken-image, a cruising lane of the subject vehicle is distinguished from the adjacent lane area, and a detection of another vehicle is performed on each monitoring area, whereby it is judged whether another vehicle detected exists in the subject lane or the adjacent lane. In this case, since a monitoring area is limited, the processing time is reduced.

With respect to the above prior art vehicle-use surroundings monitoring systems, however, stationary objects, such as tiles in a tunnel, poles of guard rails, road side-objects like a safety zone a zebra pattern with regular intervals and a similar painted pattern on the road, would be detected as approaching objects, whereby a false alarm would be generated. And, the above false alarm could be raised by fluctuation of the taken-image cause by rock-and-roll of the vehicle.

Here, an image processing called correlation technique is adopted in searching the same point of the two images stated above. The correlation technique is described in reference to FIG. 12 hereinafter. On the image taken at time t a window W1 with respect to a notable point Q (FIG. 12a) is set.

Next, the window W1 with respect to the point Q is scaned over the image taken at time t+Δt so that absolute values of the luminance difference between all the pixels in the window W1 at time t and all the corresponding pixels in the window W1 at time t+Δt are obtained. A window W2 at which the sum total of the absolute values of the luminance difference is the minimum is obtained, and a point R, corresponding to the point Q, in the window W2 is obtained (FIG. 12b).

Here, since an approaching object relative to the subject vehicle is, as shown in FIG. 11, exists in a divergent direction from FOE (Focus of Expansion), the window W1 may be shifted in the divergent direction from the FOE so that the processing can be speeded up.

In the above art using the luminance difference, when the same patterns are repeated at regular intervals, a point defferent from the point Q can be misrecognized as the same point because the luminance in the window is almost equal irrespective of any window in the image, whereby a stationary object can be detected as an approaching object.

### SUMMARY OF THE INVENTION

In view of the foregoing, an object of the present invention is to provide a vehicle-use surroundings monitoring system which prevents a stationary object from being detected as an approaching object thereby to improve a detection accuracy of the approaching object.

In order to achieve the above object, as a first aspect of the present invention as shown in FIG. 1, a vehicle-use surroundings monitoring system comprises: an image-taking means 1 to take an image of surroundings of a subject vehicle to obtain a taken-image; and an approaching object detecting means 3a-1 to detect an approaching object approaching the subject vehicle by making use of a same point in two images obtained by the image-taking means with an interval of a specified time, wherein the approaching object detecting means detects a real approaching object except a stationary object to be mis-detected as the approaching object.

According to the first aspect of the invention, since the approaching object detecting means detects the real approaching object without mis-detecting a stationary object as an approaching object, the vehicle-use surroundings monitoring system attaining an improvement of an accuracy of detecting an approaching object can be obtained.

As a second aspect of the present invention as shown in FIG. 1, based on the first aspect, the vehicle-use surroundings monitoring system further comprises: a storing means 2d to have stored moving object images giving shape of respective moving objects, wherein the approaching object detecting means detects the real approaching object by using the moving object images.

According to the second aspect of the invention, the vehicle-use surroundings monitoring system easily capable of detecting the real approaching object by using the moving object image is obtained.

As a third aspect of the present invention, based on the second aspect, the storing means includes a motor vehicle image, a man's image, and a light vehicle image as the moving object images, and the approaching object detecting means detects the real approaching object by using the motor vehicle image when the subject vehicle is travering with a speed over a predetermined speed and detects the real approaching object by using the motor vehicle image, the man's image, and the light vehicle image when the subject vehicle is travering with a speed not more than the predetermined speed.

According to the third aspect of the invention, since the approaching object detecting means does not execute the detection processing of the real approaching object by using the man's image and the light vehicle image on the highway, the image processing can be reduces, thereby providing the vehicle-use surroundings monitoring system with the reduced throughput.

As a fourth aspect of the present invention as shown in FIG. 1, based on the first aspect, the vehicle-use surroundings monitoring system further comprises: a storing means 2d to have stored stationary object images giving shape of stationary objects which can be mis-detected as respective approaching objects, wherein the approaching object detecting means detects the real approaching object by using the stationary object images.

According to the fourth aspect of the invention, the vehicle-use surroundings monitoring system which can easily detect the real approaching object by using the stationary object image can be obtained.

As a fifth aspect of the present invention as shown in FIG. 1, based on the second or fourth aspect, the approaching object detecting means has an extracting means 3a-11 to extract an area, where a characteristic point group with a plurality of characteristic points exists, in the taken-image, and a similarity calculating means 3a-12 to calculate a similarity-degree of an image in the area extracted against the moving object images or the stationary object images and detects the real approaching object based on the calculated similarity-degree.

According to the fifth aspect of the invention, the similarity-degree is calculated by image-processing the image in the area having been extracted from the taken-images. Because the whole taken-image area does not need to be image-processed, the throughput for calculating the similarity-degree can be reduced.

As a sixth aspect of the present invention, based on the fifth aspect, the extracting means extracts the area with the characteristic point group forming the approaching object.

According to the sixth aspect of the invention, because the similarity-degree calculating processing against the moving object image or the stationary object image does not need to be carried out for the image in the area in which the characteristic point group of an object not detected as the approaching object, the throughput for calculating the similarity-degree can be reduced.

As a seventh aspect of the present invention, based on the fifth aspect, the storing means stores two or more kinds of moving object images or of the stationary object images on one frame memory, and the similarity calculating means shifts the image in the extracted area onto the frame memory so as to execute an matching with the moving object images or the stationary object images and calculates the similarity-degree.

According to the seventh aspect of the invention, because the similarity-degree can be calculated against two or more kinds of moving object images or stationary object images by executing one matching process for the image in one area, the throughput for calculating the similarity-degree can be reduced.

As an eight aspect of the present invention as shown in FIG. 1, based on any one of the first to seventh aspects, the approaching object detecting means has an optical flow detecting means 3a-13 to detect, as an optical flow, a movement of the same point in the two images obtained by the image-taking means with the interval of the specified time and detects the approaching object based on the optical flow.

According to the eighth aspect of the invention, because the approaching object can be detected by using the optical flow, two image-taking means does not need to be used, thereby attaining cost reduction.

The above and other objects and features of the present invention will become more apparent from the following description taken in conjunction with the accompanying drawings.

### BRIEF DESCRIPTION OF THE DRAWINGS

FIG. 1 is a block diagram showing a basic structure of the inventive vehicle-use surroundings monitoring system;

FIG. 2 is a block diagram showing an embodiment of the inventive vehicle-use surroundings monitoring system;

FIG. 3 is a flowchart showing a routine of the CPU 3a of the vehicle-use surroundings monitoring system of FIG. 2;

FIG. 4 is a schema to explain taken-image pixels obtained by converting an image taken by the camera 1 of the vehicle-use surroundings monitoring system of FIG. 2;

FIG. 5 is a schema to explain a differential image obtained by differential-process the taken-image pixels of FIG. 4;

FIG. 6 is a schema to explain an operation of a white line detection processing;

FIG. 7 is a schema to explain an operation of an area setting processing;

FIG. 8 is a schema to explain a detection operation of a characteristic point group;

FIG. 9 is a schema to explain an operation of a similarity-degree calculating processing;

FIGS. 10a-10d are schemata to explain a change of a rear-and-side image obtained by a camera 1;

FIG. 11 is a schema showing an image of a highway with three lanes; and

FIGS. 12a, 12b are schemata to explain an operation of searching the same point.

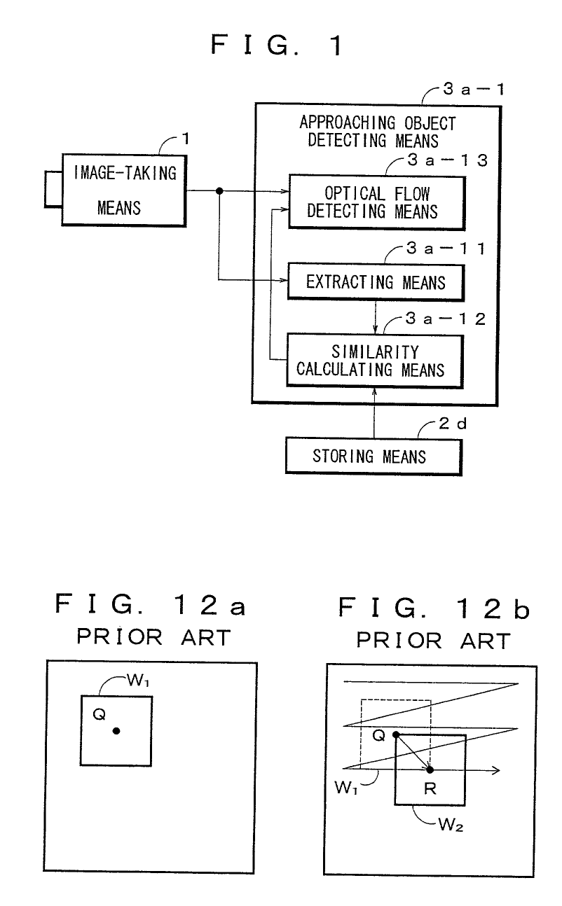

### DESCRIPTION OF THE PREFERRED EMBODIMENT(S)

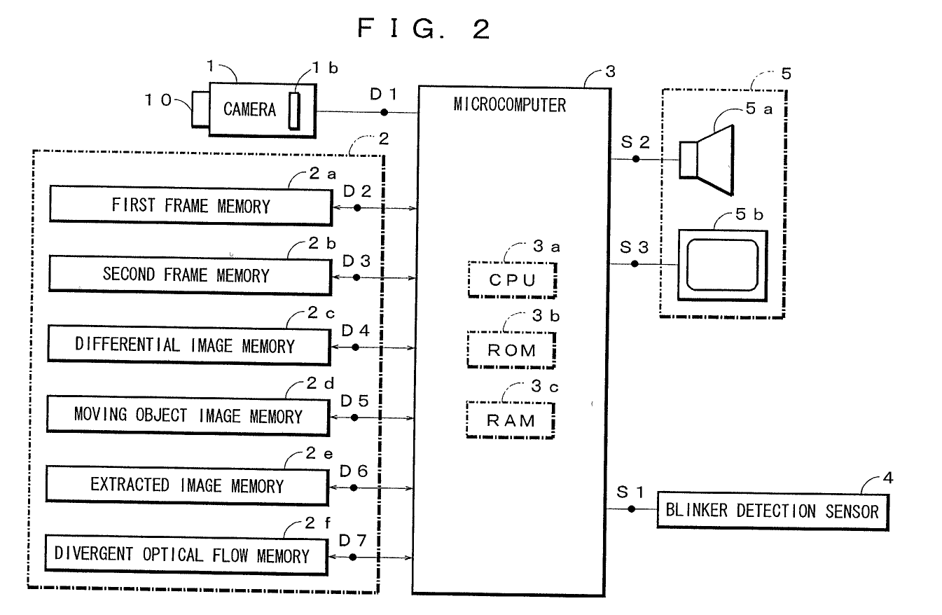

Embodiment(s) of the present invention will now be described in further detail with reference to the accompanying drawings. FIG. 2 is a block diagram showing an embodiment of the inventive vehicle-use surroundings monitoring system. A camera 1 as an onboard image-taking means image-forms an image of an angle of view decided with a lens 1a. And, the camera 1 is installed at a position from which the rear-and-side of the vehicle is a monitoring area.

A memory portion 2 has a first frame memory 2a, a second frame memory 2b, a differential image memory 2c, a moving object image memory 2d as a storing means, an extracted image memory 2e, and a divergent optical flow memory 2f. The first frame memory 2a and the second frame memory 2b temporarily store, as taken-image pixels D2,D3 respectively, a taken-image D1 formed on an image plane 1b of the camera 1 after converting it into pixels of m rows and n columns, for example 512*512 pixels with the luminance of 0-255 gradation, and output the taken-image pixels D2,D3 to a microcomputer 3.

The taken-image pixels (D2 or D3), having been converted into m*n pixels, are stored in the first or the second frame memory 2a or 2b by turns with the passage of time (t, t+Δt, t+2Δt, - - - ).

A differential image D4 formed by differentiating the taken-image pixels D2 or D3 is stored in the differential image memory 2c. And, in the moving object image memory 2d, images giving shape of vehicles such as a passenger automobile, a one-box automobile, a truck, a motorcycle, and the like are prestored as moving object images D5. An extracted image D6 extracted as a moving object candidate from the taken-image pixels D2 or D3 is stored in the extracted image memory 2e temporarily. A divergent optical flow D7 in a direction is stored in the divergent optical flow memory 2f. And, the stored divergent optical flow D7 is outputted to the microcomputer 3.

The microcomputer 3 stated above is installed in a blinker mechanism of the vehicle and connected to a blinker detection sensor 4 which outputs turning indication information S1.

The microcomputer 3 has a central processing unit (CPU) 3a which works according to the control program, ROM 3b holding the control program of the CPU 3a and preset values, and RAM 3c temporarily holding data necessary when the CPU 3a executes the operation.

The above the CPU 3a is connected to an alarm generating portion 5. The alarm generating portion 5 has a speaker 5a and a display 5b. The speaker 5a give out a voice alarm on the basis of an audio signal S2 outputted from the CPU 3a when the CPU 3a judged to be dangerous of the contact with the approaching object.

And, the display 5b displays an image taken by the camera 1 and also informs the driver of dangerousness by meas of a message thereon on the basis of a picture signal S3 outputted from the CPU 3a when the CPU 3a judged to be dangerous of the contact with the approaching object.

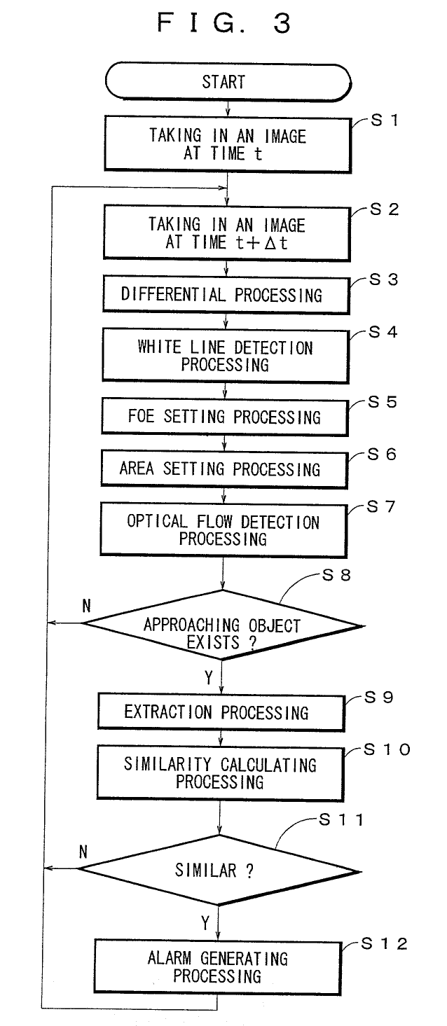

An operation of the vehicle-use surroundings monitoring system is described hereinafter in reference to a flowchart of FIG. 3. The CPU 3a takes in the taken-image D1 from the camera 1, converts the taken-image D1 into pixel data, and stores the pixel data in the first frame memory 2a as the taken-image pixels D2 at time t (Step S1).

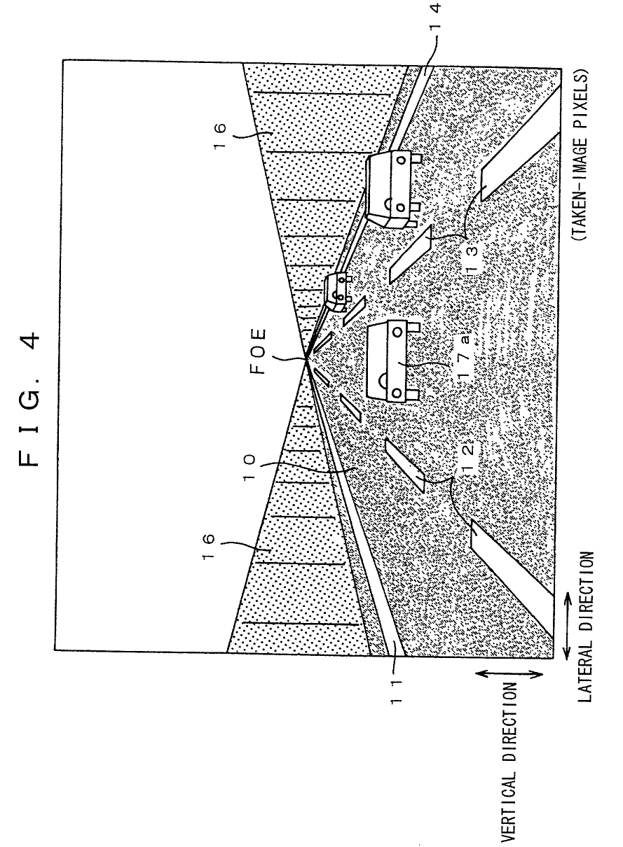

Next, the CPU 3a converts the taken-image D1 taken at time t+Δt into pixel data and outputted it to the second frame memory 2b as the taken-image pixels D3 at time t+Δt (Step S2). In the taken-image pixels D2 or D3, as shown in FIG. 4, the road 10, the white lines 11-14 drawn on the road 10, and the walls 16 standing on respective sides of the road 10 disappear at the FOE (Focus of Expansion) positioned at the right-and-left center on the display.

Because the camera 1 is mounted at the rear of the vehicle, the right side of the taken-image pixels D2 or D3 corresponds to the driving left side, and viceversa.

Next, the CPU 3a executes the differential processing on the taken-image pixels D2 or D3 whichever is of Δt ago. Here, the taken-image pixels D2 are assumed to have been image-taken Δt ago. The CPU 3a, first, laterally scans the taken-image pixels D2 shown in FIG. 4 so as to obtain the luminance value I_{m,n} of each pixel of pixels m×n, sets the luminance value as I_{m,n}=1 when a difference I_{m,n+1-}I_{m,n} between the luminance value I_{m,n+1} and the luminance value, of the adjacent pixel, I_{m,n} is not less than a predetermined luminance value, and sets the luminance value as I_{m,n}=0 when the difference I_{m,n+1-}I_{m,n} is smaller than the predetermined luminance value.

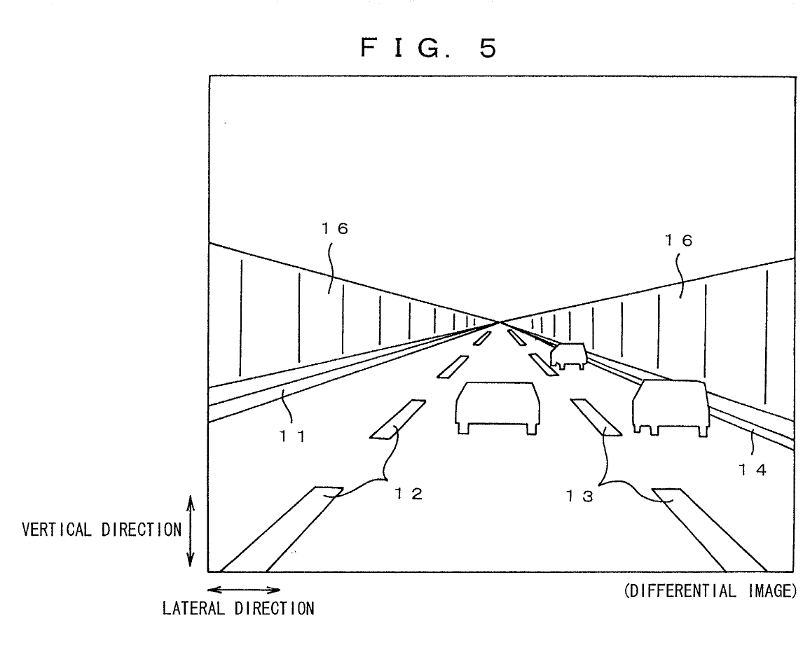

And, the scan is similarly carried out vertically in order to produce the differential image D4, of FIG. 5, made up of characteristic points on the taken-image pixels D2, and the CPU 3a outputs the differential image D4 to the differential image memory 2c.

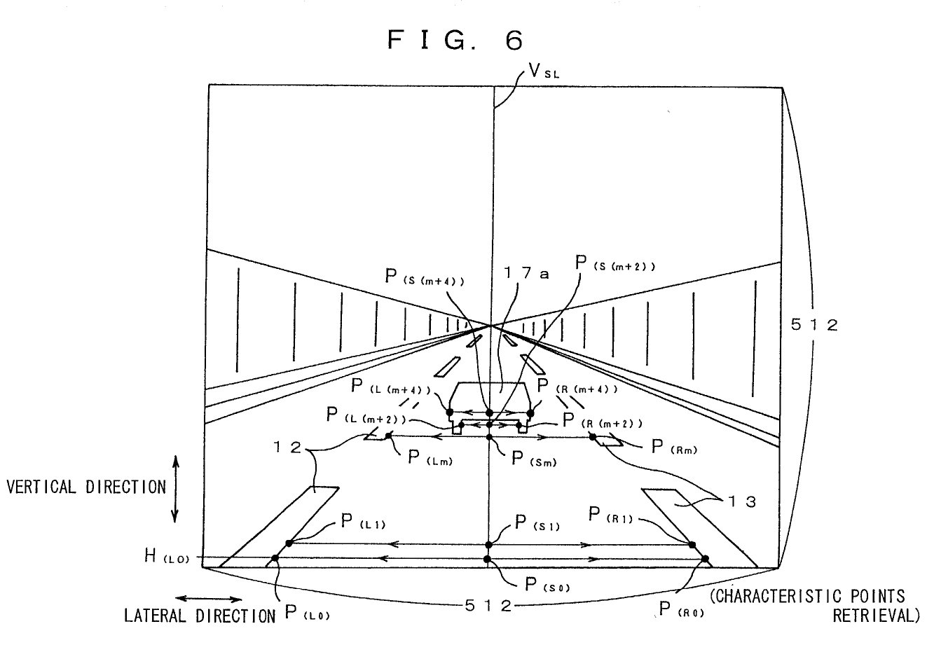

Next, the CPU 3a executes a white line detection processing on the differential image D4 for detecting characteristic points forming the white line (Step S4). The white line detection processing is described hereinafter. First, a datum line V_{SL} shown in FIG. 6 is set with respect to the differential image obtained by the above differential processing. The datum line V_{SL} runs vertically at the lateral center of the differential image D4. In other words, the datum line V_{SL} is set at the lateral center of the subject lane, between the white lines 12,13, on which the subject vehicle is traveling.

Next, the characteristic points forming the white lines 12,13 are retrieved upwardly from the horizontal line H_{(LO)} positioned at the bottom end of the display shown in FIG. 6. Specifically, the retrieval is carried out from the bottom point P_{(SO)} located on the datum line V_{SL} toward the both lateral ends. And, the characteristic point P_{(LO)} forming an edge of the white line 12 located to the left of the datum line V_{SL} and the characteristic point P_{(RO)} forming an edge the white line 13 located to the right of the datum line V_{SL} are obtained.

Following the above, the retrieval or search of the characteristic points is executed from the next characteristic point P_{(S1)} toward the both lataral ends, and the characteristic point P_{(L1)} forming an edge of the white line 12 located to the left of the datum line V_{SL} and the characteristic point P_{(R1)} forming an edge the white line 13 located to the right of the datum line V_{SL} are obtained.

The similar processing is executed successively upward on the differential image D4. With the above processings, characteristic points forming the following vehicle 17a, namely P_{(L(m+2))}, P_{(R(m+2))}, P_{(L(m+4))}, and P_{(R(m+4))}, are extracted. And, only the characteristic points on the same line are extracted from the above extracted characteristic points by means of the Hough transform. As a result, only the characteristic points forming a pair of white lines 12,13 located on both sides of the subject lane can be extracted. Here, approximate lines are produced from the extracted characteristic points by the least squares method so as to obtain the white lines 12,13.

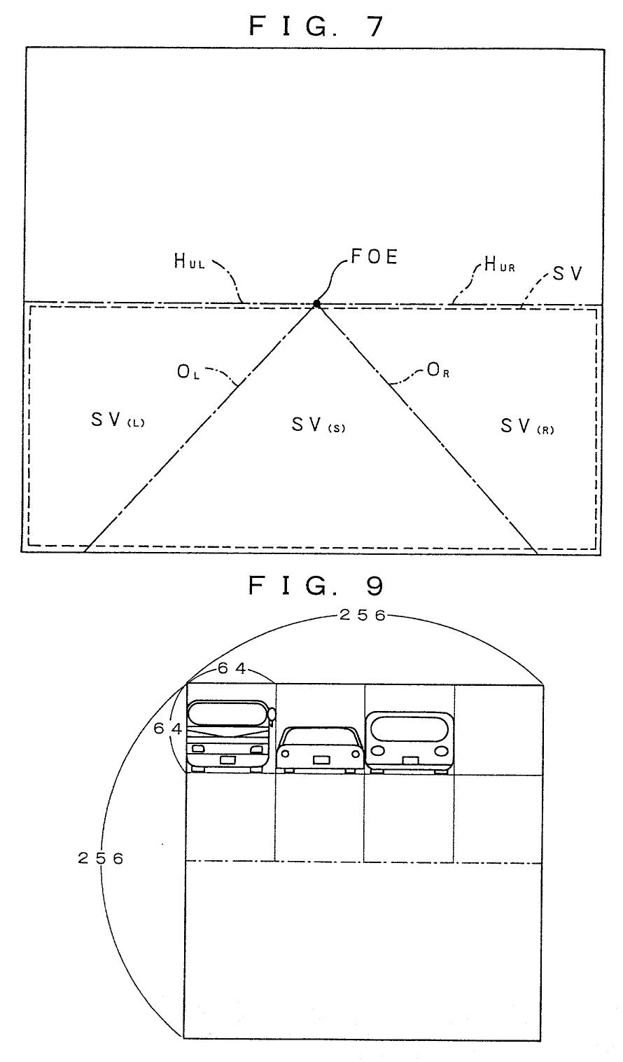

And, as shown in FIG. 7, the CPU 3a executes a FOE setting processing to extend the approximate lines O_{L},O_{R} detected as the white lines 12,13 and to set an intersection point as the FOE (Step S5). The FOE is called the infinite-point or the disappearance point. The white lines 11-14, the road 10, and the wall 16 image-taken by the camera 1 disappear at the FOE.

Next, the CPU 3a executes an area setting processing (Step S6). The area setting processing is described hereinafter. The area setting processing is carried out based on the approximate lines O_{L},O_{R} detected as the white lines 12,13 at the above Step S4 and the FOE of the above Step S5. And, as shown in FIG. 7, a right side top line H_{UR} being a boundary line laterally extending to the right from the above FOE, and a left side top line H_{UL} being a boundary line laterally extending to the left are set. With the right side top line H_{UR} and the approximate lines O_{L},O_{R}, a right side adjacent lane area SV_{(R)}, a subject lane area SV_{(S)}, and a left side adjacent lane area SV_{(L)} are set.

Next, the CPU 3a searches the same point (the corresponding points) in the taken-image pixels D2 and D3 by the correlation technique using the FOE and executes an optical flow detection processing to detect a movement of the same point as the optical flow (Step S7). With the optical flow detection processing, the CPU 3a works as an optical flow detecting means in the approaching object detecting means. Here, in the optical flow detecting processing, the CPU 3a takes in the turning indication information S1 outputted from the blinker detection sensor 4 and the above processing is executed on the area relative to the turning indication information S1.

Specifically, the optical flow is searched on the right side adjacent lane area SV_{(R)} when the turning indication information S1 to the right is outputted, the optical flow is searched on the left side adjacent lane area SV_{(L)} when the turning indication information S1 to the left is outputted, and the optical flow is searched on the subject lane area SV_{(S)} when the turning indication information S1 with no turnig intention is outputted.

Next, the CPU 3a judges whether an approaching object exists or not based on the optical flow obtained at Step S7 (Step S8). That is, if the obtained optical flow is directed to the FOE, the object is getting apart from the subject vehicle. And, when the optical flow diverges from the FOE, the object is approaching to the subject vehicle.

The optical flows of all of the stationary objects, such as scenes or markings, go to the FOE, and therefore they can be easily distinguish from approaching objects. Accordingly, the CPU 3a judges that there exists no approaching object with a danger of contact (Step S8, N), when the optical flow is directed to, i.e. converges on, the FOE or is not more than a predetermined length even if the optical flow diverges from the FOE.

On the contrary, the CPU 3a judges that an approaching object with a danger of contact exists (Step S8, Y) when the length of the optical flow diverging from the FOE is larger than the predetermined and then executes a processing of judging whether the approaching object is a stationary object (e.g. the zebra pattern) mis-detected as an approaching object.

That is, the CPU 3a acts as an extracting means of the approaching object detecting means and executes the extraction processing to extract an area of the approaching object in the taken-image pixels D2 (Step S9). This extraction processing is executed on the basis that the characteristic points are detected as a group, or a lump, for an approaching object innumerably. That is, in the extraction processing, the CPU 3a extracts the characteristic points forming the optical flows diverging from the FOE in the differential image D4 and having lengths over the predetermined length, extracts a group of the characteristic points, and extracts an area with the detected characteristic point group.

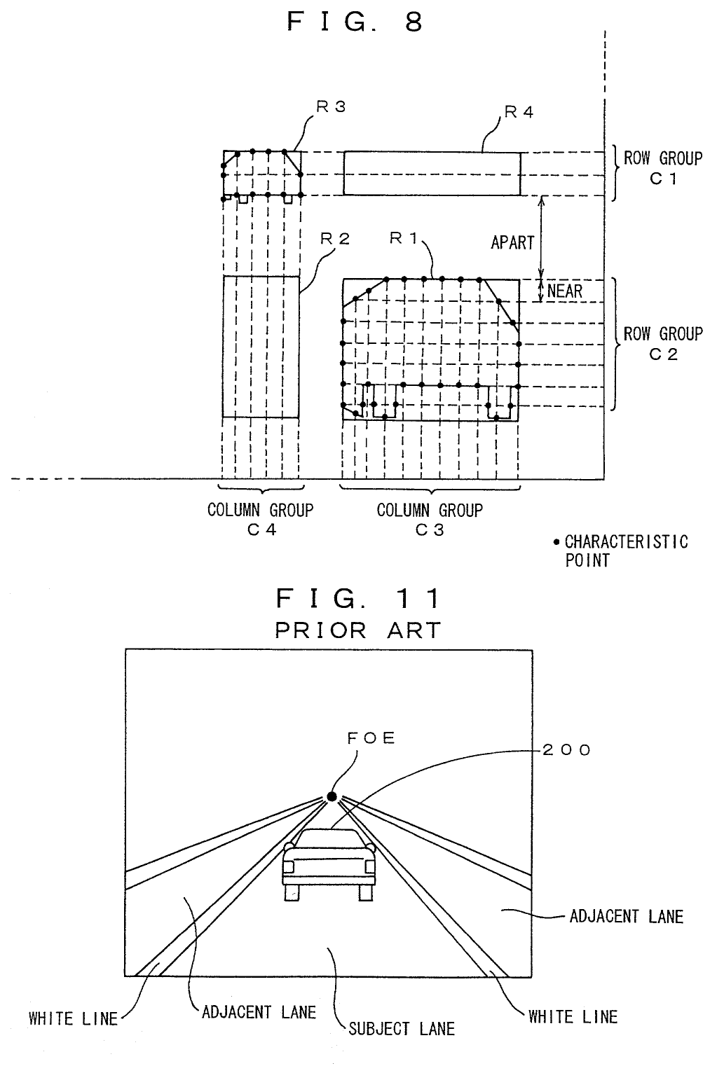

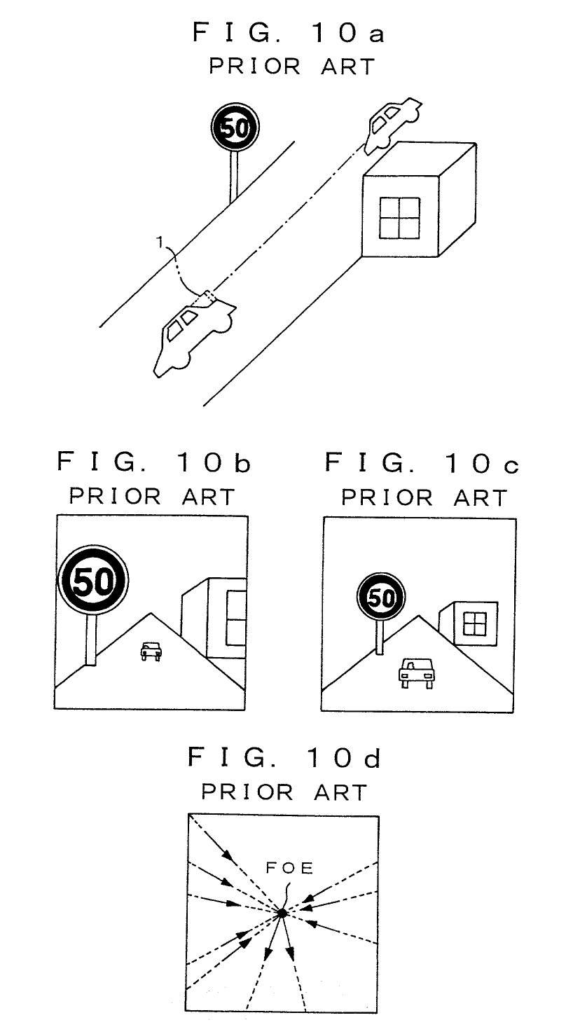

The detection of the above characteristic point group is executed as follows. First, the CPU 3a extracts rows and columns of the extracted characteristic points on the differential image D4 and detects a row group on the basis of distances of the extracted rows. A column group is detected similarly. As shown in FIG. 8, row groups C1,C2 and column groups C3,C4 are detected. Next, areas R1, R2, R3, and R4 where the row groups C1,C2 and the column groups C3,C4 intersect are obtained. And, the CPU 3a judges that the approaching objects exists at the areas R1,R3 only where the characteristic points exists. And, the CPU 3a stores the images in the areas R1,R3 as an extracted image D6 in the extracted image memory 2e.

Next, the CPU 3a acts as a similarity calculating means in the approaching object detecting means and executes a similarity-degree calculating processing to calculate the similarity-degree of the extracted image D6 with respect to the moving object image D5 stored in the moving object image memory 2d (Step S10). Here, as shown in FIG. 9, moving object images D5 showing shapes of a truck, a passenger automobile, a wagon automobile, and the like are stored in the moving object image memory 2d, i.e. on one frame memory. More specifically, when the frame memory has, for example, 256*256 pixels, the moving object images D5 each having 64*64 pixels are arranged.

And, the CPU 3a converts the above extracted image D6 into 64*64 pixels similarly to the moving object image D5, scans the frame memory to do the matching, and calculates the similarity-degree with respect to the moving object image D5. And, the CPU 3a judges that the approaching object is a moving object if there is a moving object image D5 with the similarity-degree being not less than the predetermined value (Step S11, Y) and executes an alarm generating processing (Step S12) to output an audio signal S2 or a picture signal S3, which informs that an approaching object with a danger of contact exists, to the speaker 5a or the display 5b.

On the contrary, if all the similarity-degrees calculated at the similarity-degree calculating processing are smaller than the predetermined value (Step S11, N), the CPU 3a judges that the approaching object detected at Step S8 is a stationary object having been mis-detected as an approaching object and goes back to Step S2 without executing the above alarm generating processing. As above, an approaching object can be detected with a high accuracy by rejecting a stationary object.

In the embodiment stated above, in the similarity-degree calculating processing the extracted image D6 shifts on one frame memory with a plurality of moving object images D5, while carrying out the operation of the similarity-degree by means of the matching. This method is generally called the matched filtering, which has an advantage of obtaining the similarity-degree by one matching processing for one extracted image D6.

And in the embodiment stated above, an approaching object to be the real one (hereinafter described as a real approaching object) is detected by calculating the similarity-degree between the extracted image D6, which is an area having a characteristic point group, and the moving object image D5. With this, an image in an extracted area of the taken-image pixels D2 or D3 is image-processed and the similarity-degree is calculated. Therefore, because the whole taken-image area does not need to be image-processed, the throughput can be reduced.

Here, because the present system mainly monitors the surroundings in the highway, only the motor vehicle images are stored as the moving object image D5. However, taking into consideration of the general road, a man and a light vehicle, such as a bicycle, should be added to the moving object image D5.

In this case, the man's image and the light vehicle image in addition to the motor vehicle image are stored in the moving object image memory 2. And, when a vehicle is traveling with a speed over a predetermined speed, the system judges that the vehicle is traveling on a highway and therefore the similarity-degree is calculated based on the motor vehicle image. And, when a vehicle is traveling with a speed equal to, or under, the predetermined speed, the system judges that the vehicle is traveling on a general road and therefore the similarity-degree is calculated based on the man's image and the light vehicle image in addition to the motor vehicle image. With this, the similarity-degree calculating processing does not need to be executed for the man's image and the light vehicle image when the vehicle is traveling on the highway.

And, in the embodiment stated above, the real approaching object is detected by using the moving object image D5. However, the stationary object images such as tiles of a tunnel, poles, a zebra zone, which would be mis-detected as the approaching objects, may be stored in advance so that a real approaching object can be detected by using these stationary object images. In this case, the similarity-degree between the extracted image D6 and the stationary object image is calculated in the similarity-degree calculating processing of Step S11. And, at the next Step S12, the real approaching object is detected when all the calculated similarity-degrees are not more than the predetermined value, and an alarm is given out.

And, in the embodiment stated above, the extraction processing and the similarity-degree calculating processing are carried out only for the characteristic points forming the approaching object, thereby reducing the throughput. However, if the throughput does not need to be reduces, the extraction processing and the similarity-degree calculating processing may be executed, for example, for the characteristic points forming the differential image D4 so that the optical flow can be detected for the characteristic points recognized to be the moving object.

And, in the embodiment stated above, though the camera 1 is installed at the rear-and-side, the camera 1 may be installed at the front-and-side.

Further, in the embodiment stated above, the degree of danger is judged by detecting an approaching vehicle by using the optical flow in a taken-image obtained by the camera 1. However, the present system can be applied to a modified system wherein a position of an approaching vehicle with respect to the subject vehicle is calculated, for example, by using two cameras and the degree of danger can be judged based on the calculated position.

According to the above-described structures of the present invention, the following advantages are provided.

(1) Since the approaching object detecting means detects the real approaching object without mis-detecting a stationary object as an approaching object, the vehicle-use surroundings monitoring system attaining an improvement of an accuracy of detecting an approaching object can be obtained.

(2) The vehicle-use surroundings monitoring system easily capable of detecting the real approaching object by using the moving object image is obtained.

(3) Since the approaching object detecting means does not execute the detection processing of the real approaching object by using the man's image and the light vehicle image on the highway, the image processing can be reduces, thereby providing the vehicle-use surroundings monitoring system with the reduced throughput.

(4) The vehicle-use surroundings monitoring system which can easily detect the real approaching object by using the stationary object image can be obtained.

(5) The similarity-degree is calculated by image-processing the image in the area having been extracted from the taken-images. Because the whole taken-image area does not need to be image-processed, the throughput for calculating the similarity-degree can be reduced.

(6) Since the similarity-degree calculating processing against the moving object image or the stationary object image does not need to be carried out for the image in the area in which the characteristic point group of an object not detected as the approaching object, the throughput for calculating the similarity-degree can be reduced.

(7) Since the similarity-degree can be calculated against two or more kinds of moving object images or stationary object images by executing one matching process for the image in one area, the throughput for calculating the similarity-degree can be reduced.

(8) Since the approaching object can be detected by using the optical flow, two image-taking means does not need to be used, thereby attaining cost reduction.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A vehicle-use surroundings monitoring system comprising:
an image-taking means to take an image of surroundings of a subject vehicle to obtain a taken-image; and
an approaching object detecting means to detect an approaching object approaching the subject vehicle by making use of a same point in two images obtained by the image-taking means with an interval of a specified time,
wherein the approaching object detecting means detects a real approaching object except a stationary object to be mis-detected as the approaching object.

2. The vehicle-use surroundings monitoring system as set forth in claim 1, further comprising:
a storing means to have stored moving object images giving shape of respective moving objects,
wherein the approaching object detecting means detects the real approaching object by using the moving object images.

3. The vehicle-use surroundings monitoring system as set forth in claim 2, wherein
the storing means includes a motor vehicle image, a man's image, and a light vehicle image as the moving object images, and
the approaching object detecting means detects the real approaching object by using the motor vehicle image when the subject vehicle is travering with a speed over a predetermined speed
and detects the real approaching object by using the motor vehicle image, the man's image, and the light vehicle image when the subject vehicle is travering with a speed not more than the predetermined speed.

4. The vehicle-use surroundings monitoring system as set forth in claim 1, further comprising:
a storing means to have stored stationary object images giving shape of stationary objects which can be mis-detected as respective approaching objects,
wherein the approaching object detecting means detects the real approaching object by using the stationary object images.

5. The vehicle-use surroundings monitoring system as set forth in claim 2, wherein
the approaching object detecting means has an extracting means to extract an area, where a characteristic point group with a plurality of characteristic points exists, in the taken-image, and a similarity calculating means to calculate a similarity-degree of an image in the area extracted against the moving object images or the stationary object images and
detects the real approaching object based on the calculated similarity-degree.

6. The vehicle-use surroundings monitoring system as set forth in claim 4,
the approaching object detecting means has an extracting means to extract an area, where a characteristic point group with characteristic points exists, in the taken-image, and a similarity calculating means to calculate a similarity-degree of an image in the area extracted against the moving object images or the stationary object images and
detects the real approaching object based on the calculated similarity-degree.

7. The vehicle-use surroundings monitoring system as set forth in claim 5, wherein
the extracting means extracts the area with the characteristic point group forming the approaching object.

8. The vehicle-use surroundings monitoring system as set forth in claim 5, wherein
the storing means stores two or more kinds of moving object images or of the stationary object images on one frame memory, and
the similarity calculating means shifts the image in the extracted area onto the frame memory so as to execute an matching with the moving object images or the stationary object images and calculates the similarity-degree.

9. The vehicle-use surroundings monitoring system as set forth in claim 1, wherein
the approaching object detecting means has an optical flow detecting means to detect, as an optical flow, a movement of the same point in the two images obtained by the image-taking means with the interval of the specified time and detects the approaching object based on the optical flow.

10. The vehicle-use surroundings monitoring system as set forth in claim 2, wherein
the approaching object detecting means has an optical flow detecting means to detect, as an optical flow, a movement of the same point in the two images obtained by the image-taking means with the interval of the specified time and detects the approaching object based on the optical flow.

11. The vehicle-use surroundings monitoring system as set forth in claim 3, wherein
the approaching object detecting means has an optical flow detecting means to detect, as an optical flow, a movement of the same point in the two images obtained by the image-taking means with the interval of the specified time and detects the approaching object based on the optical flow.

12. The vehicle-use surroundings monitoring system as set forth in claim 4, wherein
the approaching object detecting means has an optical flow detecting means to detect, as an optical flow, a movement of the same point in the two images obtained by the image-taking means with the interval of the specified time and detects the approaching object based on the optical flow.

13. The vehicle-use surroundings monitoring system as set forth in claim 5, wherein
the approaching object detecting means has an optical flow detecting means to detect, as an optical flow, a movement of the same point in the two images obtained by the image-taking means with the interval of the specified time and detects the approaching object based on the optical flow.

14. The vehicle-use surroundings monitoring system as set forth in claim 6, wherein
the approaching object detecting means has an optical flow detecting means to detect, as an optical flow, a movement of the same point in the two images obtained by the image-taking means with the interval of the specified time and detects the approaching object based on the optical flow.

15. The vehicle-use surroundings monitoring system as set forth in claim 7, wherein
the approaching object detecting means has an optical flow detecting means to detect, as an optical flow, a movement of the same point in the two images obtained by the image-taking means with the interval of the specified time and detects the approaching object based on the optical flow.

16. The vehicle-use surroundings monitoring system as set forth in claim 8, wherein
the approaching object detecting means has an optical flow detecting means to detect, as an optical flow, a movement of the same point in the two images obtained by the image-taking means with the interval of the specified time and detects the approaching object based on the optical flow.
